(19) United States
(12) Patent Application Publication
(10) Pub. No.: US 2016/0029091 A1
(43) Pub. Date: Jan. 28, 2016

(54) METHOD OF DISPLAYING A REGION OF INTEREST IN A VIDEO STREAM

(71) Applicant: CANON KABUSHIKI KAISHA, Ohta-ku, Tokyo (JP)

(72) Inventors: HERVÉ LE FLOCH, RENNES (FR); FRÉDÉRIC MAZE, LANGAN (FR); NAËL OUEDRAOGO, Maure De Bretagne (FR)

(73) Assignee: CANON KABUSHIKI KAISHA, Tokyo (JP)

(21) Appl. No.: 14/761,143

(22) PCT Filed: Jan. 15, 2014
(86) PCT No.: PCT/EP2014/050699

§ 371 Date: Jul. 15, 2015

(30) Foreign Application Priority Data
Jan. 18, 2013 (GB) 1300949.3

(51) Int. Cl. H04N 21/4728; H04N 21/854; H04N 19/463; H04N 21/2343

(52) U.S. Cl. CPC H04N 21/4728; H04N 21/234345; H04N 21/23439; H04N 21/85406; H04N 19/463

(57) ABSTRACT

A method of processing video data comprising including a link between first encoded image data in a first encoded video stream and second encoded image data in a second encoded video stream, the first and second encoded image data corresponding to a same spatial area of the images of the first and second encoded video streams. Embodiments of the invention provide high resolution display of specific region of interest without a priori knowledge of the position of the region of interest.

The present invention relates to video data processing for video streaming.

In particular, the present invention relates to video data processing making it possible to display a portion of images of a video stream with a higher quality than the other portions of the images.

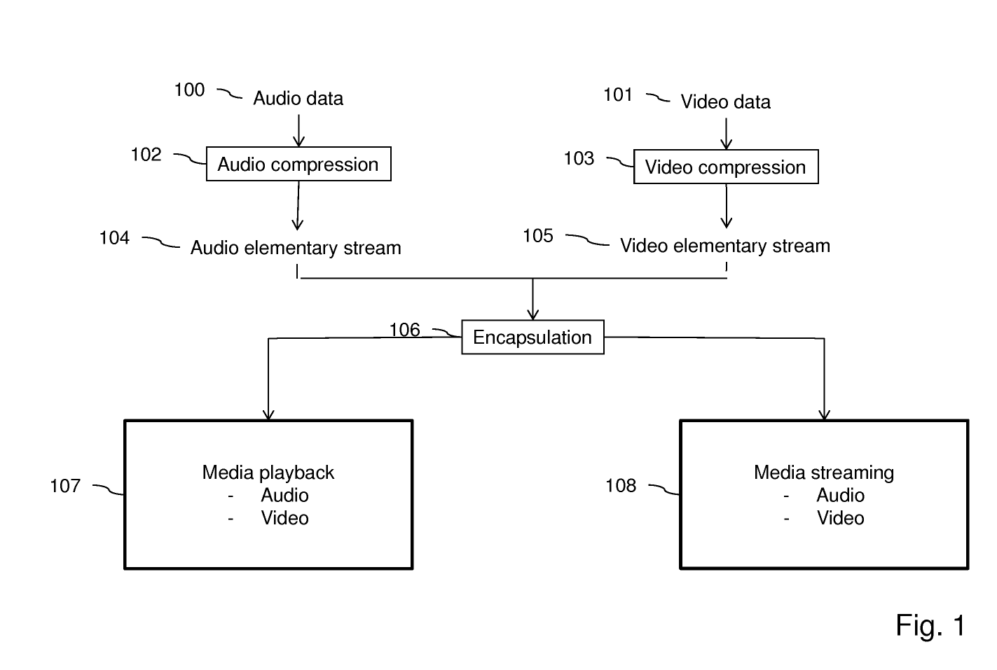

Video streaming is illustrated in FIG. 1.

Audio data and video data are acquired during respective steps 100 and 101. The audio data are compressed during a step 102 using a compression algorithm such as MP3. In parallel, video data are compressed during a step 103 using algorithms such as MPEG4, AVC, HEVC, SVC or the future scalable extension of HEVC. Once compression has been performed, audio and video elementary streams 104 and 105 are respectively obtained.

Next, during a step 106, the elementary streams are encapsulated into an encapsulation file as a global media presentation. For example, the ISO BMFF standard (acronym for ISO Base Media File format), or its extension to AVC, SVC, HEVC or the future scalable extension of HEVC may be used for describing as the content of the encoded audio and video elementary streams a global media presentation. The encapsulation file may contain:
media data (the audio and video elementary streams), and
metadata describing the media data.

The encapsulated file can be used directly for a local playback during step 107. It can also be streamed over a network during step 108. For example, DASH (acronym for Dynamic Adaptive Streaming over HTTP) can be used as a streaming protocol.

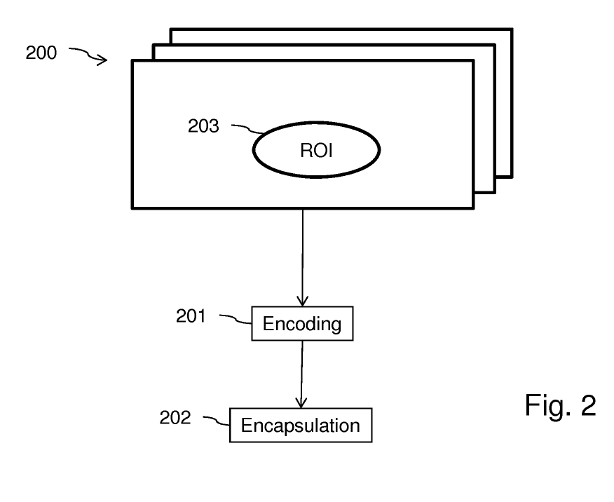

A need exists for easily displaying with better quality spatial sub-parts of a video. This functionality is illustrated in FIG. 2.

This figure shows frames 200 of a video stream. For example, the video stream is the output of a camera sensor. The video stream is encoded during a step 201 and the encoded video stream is encapsulated during a step 202 into a container (encapsulation file). The container is a file containing the elementary stream (media data) and a description of the elementary stream (metadata).

One solution to display a high quality spatial sub-part of a video on an end user display is to transmit the full encoded video with full quality to the end user receiver device. However, in case of UHD (Ultra High Definition) video, transmitting the full encoded video stream requires a high bitrate that may not be supported by the receiver's processing power or display capabilities.

The end user may though select a region of interest of the video stream (ROI) 203 and make request for receiving and displaying the ROI with a quality higher than the other parts of the video (the other parts being received and displayed with a basic quality),

For example, the ROI may be encoded with the same spatial resolution than the remainder of the video but with a higher quality. Also, the whole video may be spatially up-sampled with complementary details for improving the visual rendering of the ROI. However, due to the initial encoding in step 201, implementation of this functionality is difficult.

Encoding the whole initial video stream with high quality and transcoding the video when the ROI is known necessitates performing highly complex computations.

Streaming the pixels of the ROI with a high quality, when the ROI is known in advance, requires data extraction from the encapsulation file, transcoding and a new encapsulation. These operations are complex and necessitate a large amount of processing resources. Also, having a ROI set once and for all in advance cannot give the user the opportunity to select dynamically the ROI.

Thus, there is need for enhancing video streaming so as to make it possible to display a ROI of a video stream with a better quality.

A first aspect of the invention relates to a method of processing a video stream for encapsulation into an encapsulation file, the method comprising including in at least one first encoded video stream of a plurality of encoded video streams, at least one link between:
first encoded image data in said at least one first encoded video stream, and
second encoded image data in at least one second encoded video stream of the plurality, and

wherein said at least one first and second encoded image data correspond to a same spatial area of the images of the first and second encoded video streams.

Encapsulation files obtained by implementation of a method according to the first aspect may comprise several encoded video streams with data portions encoded according to several levels of resolution.

Such encapsulation files make it possible for end devices to select for a given image area or region of interest, a suitable resolution according to a user's needs, network conditions or other criteria.

Thus, any region of interest in the video stream can be reassembled in order to be displayed with a better quality or resolution. The region of interest can be unknown during encoding.

The encapsulation files provided make it possible to simplify the processing needed for generating video data for enhanced display of a region of interest.

According to embodiments, each encoded video stream comprises encoded images with at least one same respective image portion encoded with a higher resolution than the other image portions.

High resolution may be understood as high image quality without any difference in terms of number of pixels between high resolution image portions and low resolution image portions.

For example, said first encoded image data is not encoded with a higher resolution in the first encoded video stream, and wherein said second encoded image data is encoded with a higher resolution in the second encoded video stream.

Thus, resolution of the region of interest may be increased upon request of the end user. The end user may wish to see in details a particular area in a video stream.

The resolution of the region of interest may also be decreased due to network conditions. Therefore, instead of using the image data encoded with high resolution, the end device may use the image data encoded with low resolution.

According to embodiments, each one of the plurality of encoded video streams is encoded with a base layer with a low resolution and an enhancement layer with said images with at least one same respective image portion encoded with a higher resolution than the other image portions.

Thus, scalable codecs may be implemented.

For example, said base layer is the same for the plurality of encoded video streams.

The first and the at least one second image data may belong to respective frames of the first and at least one second encoded video streams, the frames having a same temporal position in said encoded video streams.

Thus, the frames may belong to a same media segment.

For example, each encoded video stream is encapsulated with a group data portion identifying a group of encoded video streams to which it belongs, each encoded video stream of the group being linked to another encoded video stream of the group.

Thus, the end device may identify whether an image portion may be enhanced and may identify the other image portions to be used to do so.

According to embodiments, each image of the encoded video streams of the plurality is subdivided into a plurality of image portions, wherein the images of the encoded video streams are subdivided according to a same subdivision grid, and wherein said at least one first and second encoded image data correspond to a same image portion of the grid.

The subdivision grid may define tiles of a video stream.

The plurality of encoded video streams may be encoded from a common subdivided video stream, each image of said common subdivided video stream being subdivided into a plurality of image portions according to said same subdivision grid.

For example, the method further comprises encapsulating, into said encapsulation file, said common subdivided video stream encoded with a low resolution.

Said at least one second image data may be associated with a resolution level data indicating a level of resolution with which said at least one second image data is encoded.

The resolution level data may comprise a superimposition data indicating a position of the at least one second image data in a superimposition of image data layers.

Thus, the image data to display for a given image portions may be easily identified.

A second aspect of the invention relates to a method of processing an encapsulation file for displaying video data, the method comprising the following steps:
accessing an encapsulation file comprising a plurality of encapsulated encoded video streams,
identifying, in at least one first encoded video stream of the encapsulation file, at least one link between first encoded image data in said at least one first encoded video stream, and second encoded image data in at least one second encoded video stream of said plurality, wherein said at least one first and second encoded image data correspond to a same spatial area of the images of the first and second encoded video streams,
replacing, in said first encoded video stream, said first encoded image data with said second encoded image data,
decoding said first encoded video stream, and
generating a video signal based on video data obtained by said decoding.

Methods according to the second aspect take advantage of encapsulation files generated according to the first aspect.

The method may further comprise deleting, in said first encoded video stream, said link, once said substitution is performed.

For example, each encapsulated encoded video stream comprises encoded images with at least one same respective image portion encoded with a higher resolution than the other image portions.

Said first encoded image data may be not encoded with a higher resolution in the first encoded video stream, and said second encoded image data may be encoded with a higher resolution in the second encoded video stream.

For example, each one of the plurality of encoded video streams is encoded with a base layer with a low resolution and an enhancement layer with said images with at least one same respective image portion encoded with a higher resolution than the other image portions.

Said base layer may be the same for the plurality of encoded video streams.

Said first and second image data may belong to respective frames of the first and second encoded video streams, said frames having a same temporal position in said encoded video streams.

For example, each encoded video stream is encoded with a group data portion identifying a group of encoded video streams to which it belongs, each encoded video stream of the group being linked to another encoded video stream of the group.

The method may further comprise selecting said first and at least one second encoded video streams as having respective group data portions identifying a same group of encoded video streams.

For example, each image of the encoded video streams of the plurality is subdivided into a plurality of image portions, wherein the images of the video streams are subdivided according to a same subdivision grid, and wherein said at least one first and second encoded image data correspond to a same image portion of the grid.

Said plurality of encoded video streams may be encoded from a common subdivided video stream, each image of said common subdivided video stream being subdivided into a plurality of image portions according to said same subdivision grid.

For example, said encapsulation file comprises said common subdivided video stream encoded with a low resolution.

Said at least one second image data may be associated with a resolution level data indicating a level of resolution with which said at least one second image data is encoded.

Said resolution level data may comprise a superimposition data indicating a position of the at least one second image data in a superimposition of image data layers and the at least one second image data may be displayed according to said position.

A third aspect of the invention relates to a device for implementing a method according to the first aspect, such device may comprise means for implementing the steps of the method, such as a processing unit configured for executing said steps.

A fourth aspect of the invention relates to a device for implementing a method according to the second aspect. Such device may comprise means for implementing the steps of the method, such as a processing unit configured for executing said steps.

A fifth aspect of the invention relates to systems comprising at least one device according to the fourth and fifth aspects of the invention.

A sixth aspect of the invention relates to computer programs and computer program products comprising instructions for implementing methods according to the first and/or second aspect(s) of the invention, when loaded and executed on computer means of a programmable apparatus such as an encoding device, a server device and/or a client device.

According to an embodiment, information storage means readable by a computer or a microprocessor store instructions of a computer program, that it makes it possible to implement a method according the first and/or second aspect of the invention.

The objects according to the second, third, fourth, fifth and sixth aspects of the invention provide at least the same advantages as those provided by the method according the first aspect of the invention.

Other features and advantages of the invention will become apparent from the following description of non-limiting exemplary embodiments, with reference to the appended annexes and drawings, in which, in addition to FIGS. 1 and 2:

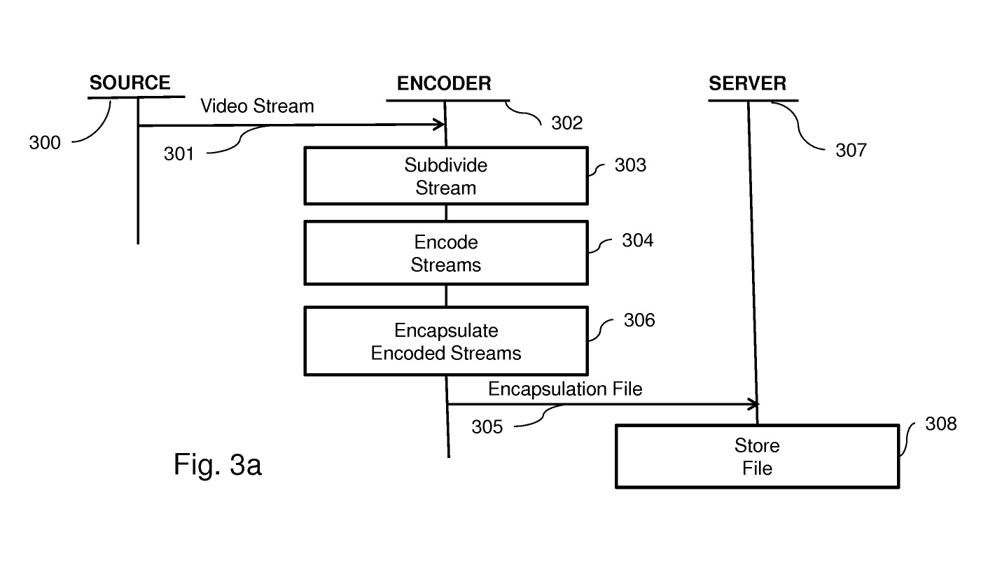

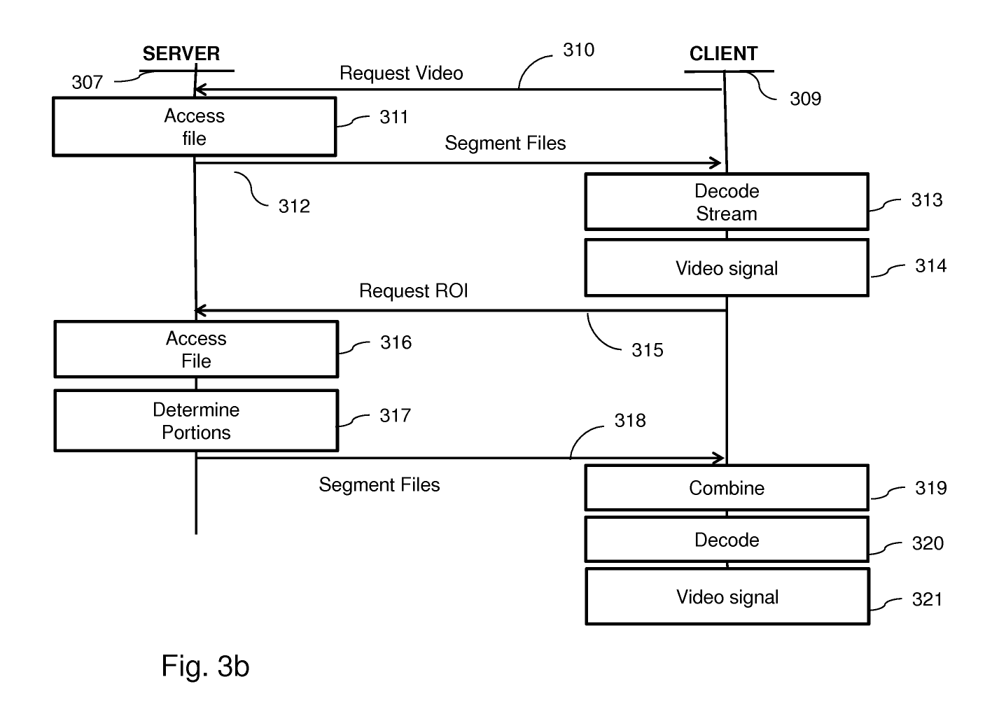

FIGS. 3a and 3b are a schematic illustration of a general context of implementation of embodiments,

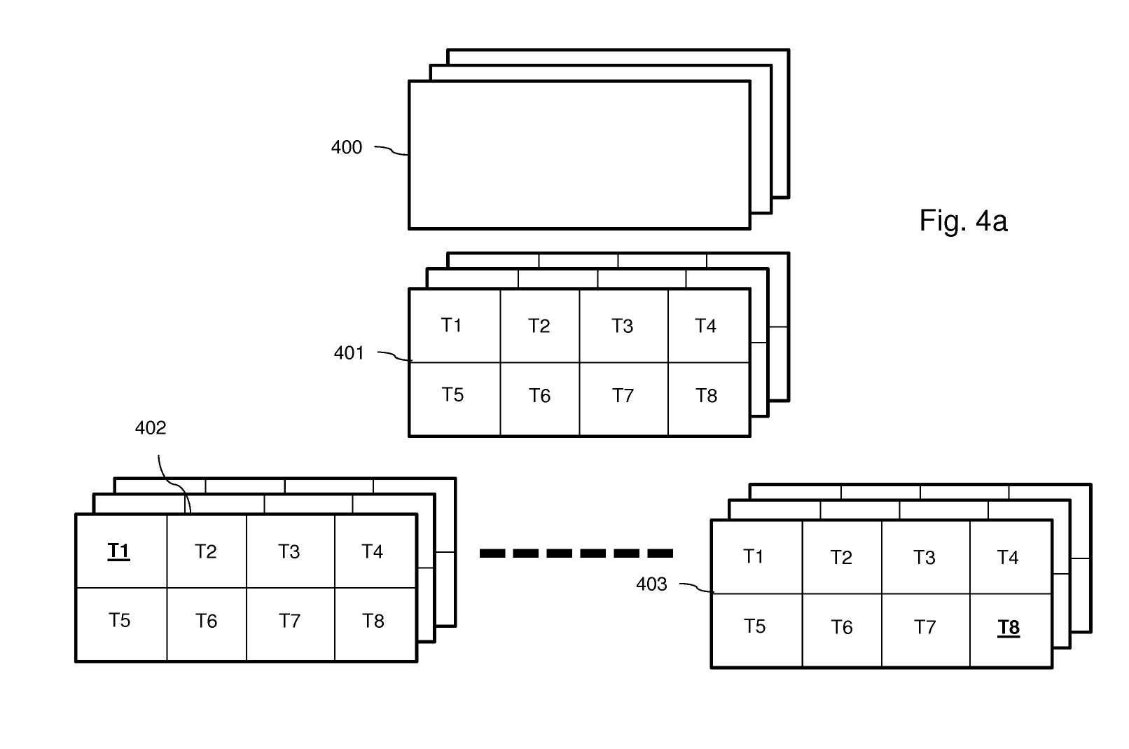

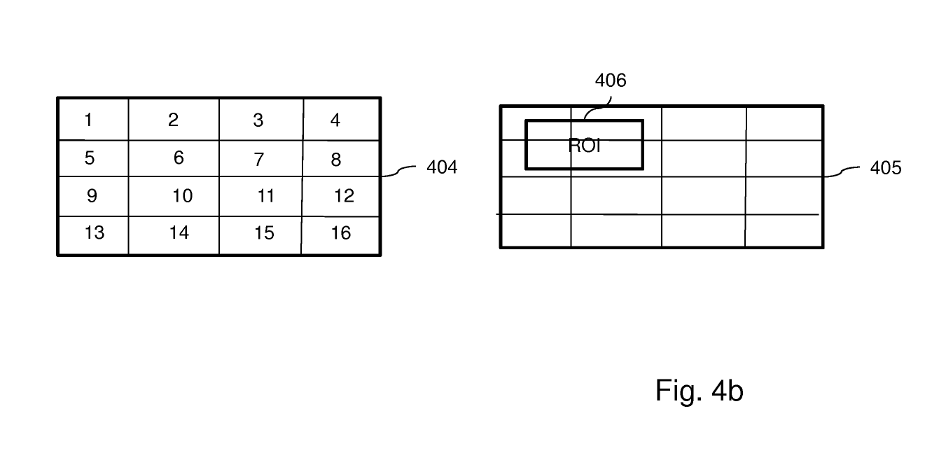

FIGS. 4a and 4b are schematic illustrations of encoding and displaying according to embodiment,

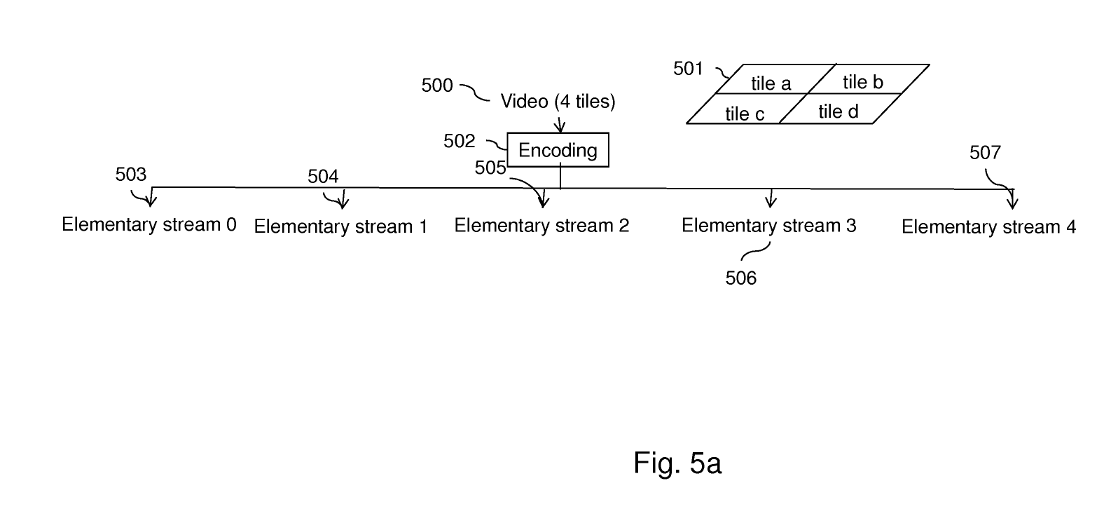

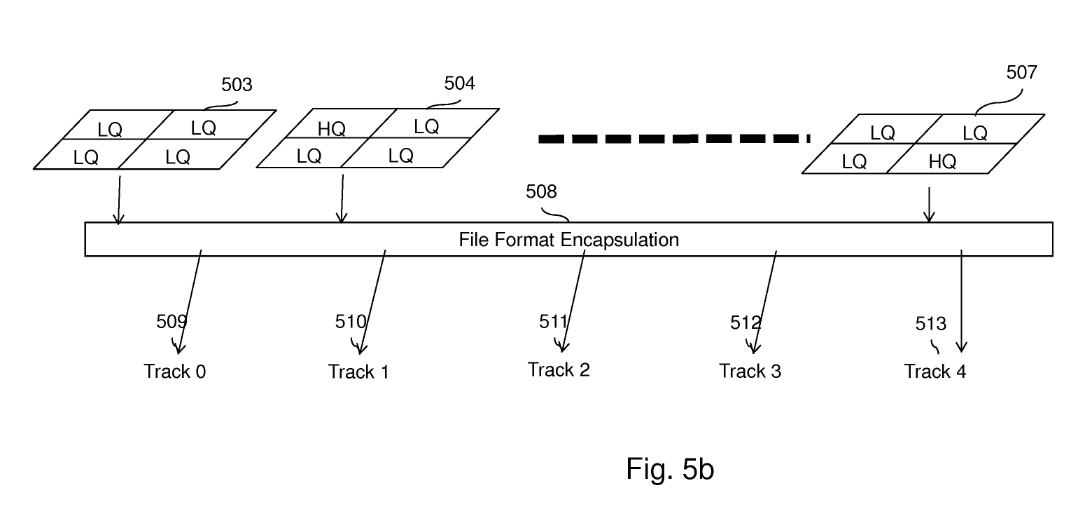

FIGS. 5a and 5b are schematic illustrations of encapsulation with a non-scalable codec according to embodiments,

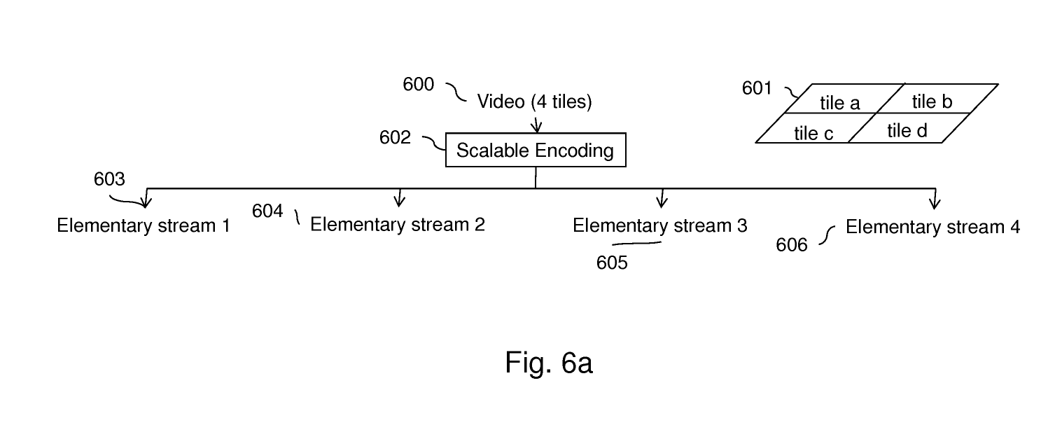

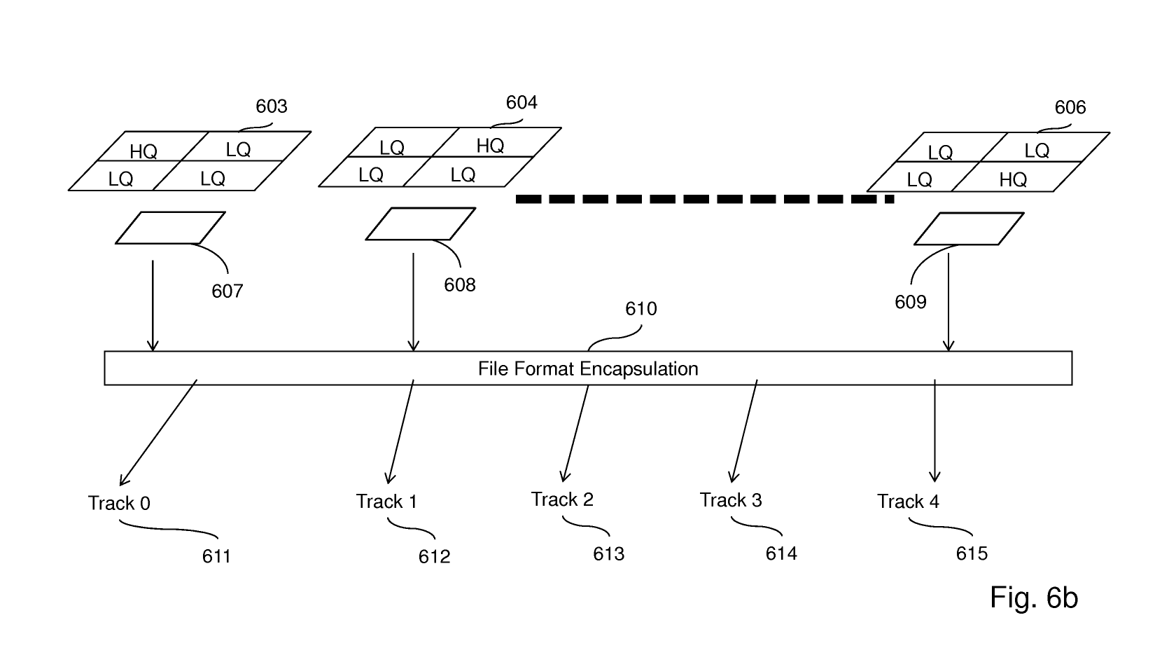

FIGS. 6a and 6b are schematic illustrations of encapsulation with a scalable codec according to embodiments,

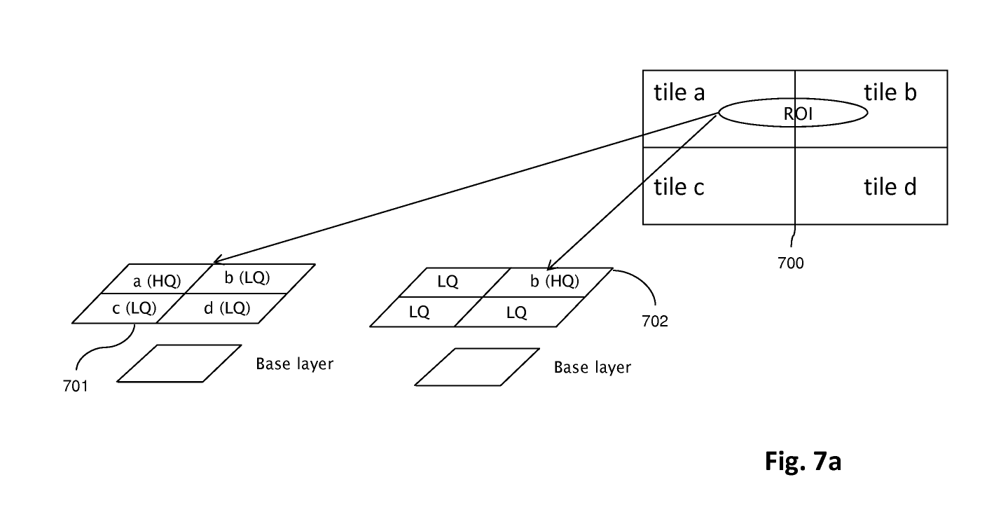

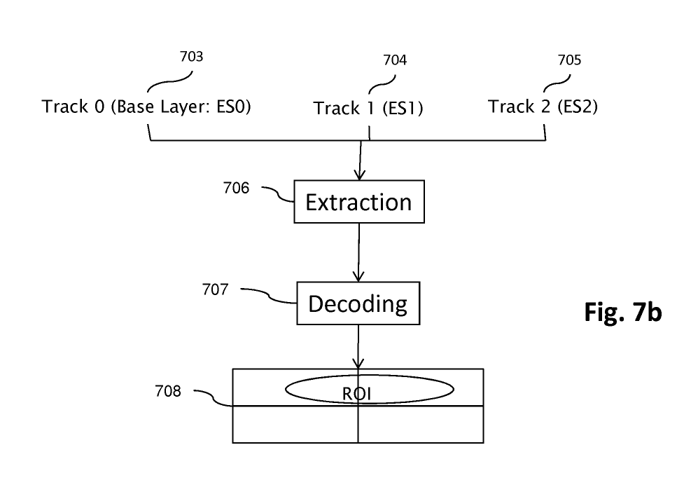

FIGS. 7a and 7b are illustrations of the use of video tracks according to embodiments

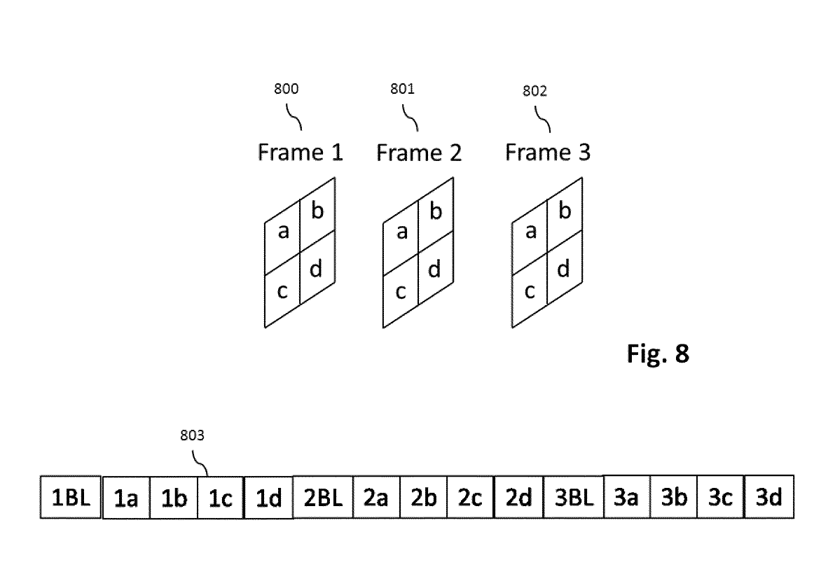

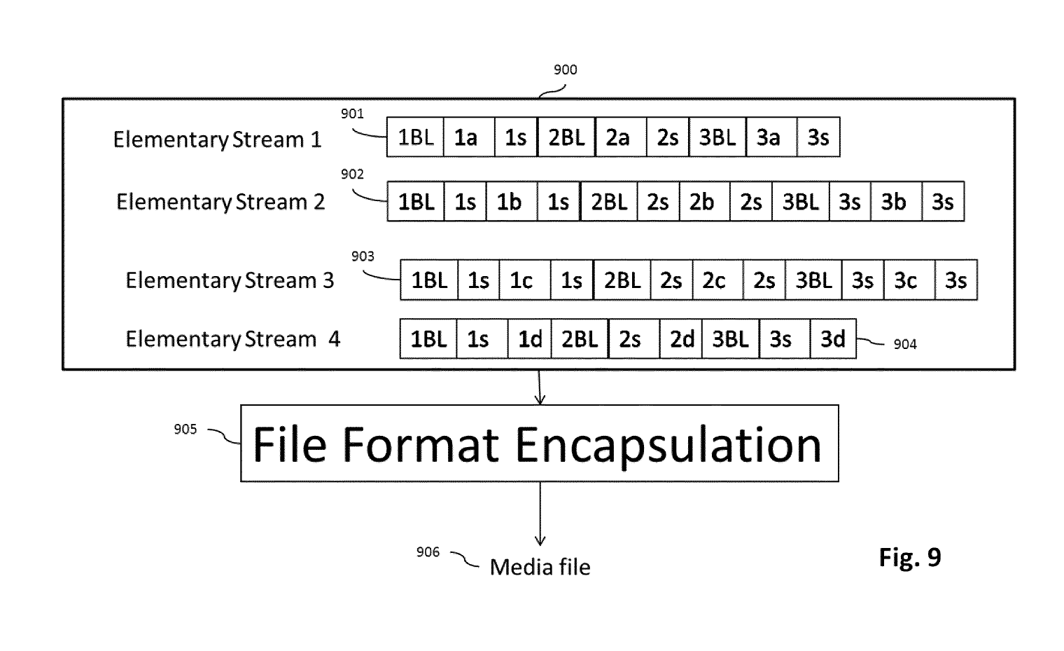

FIGS. 8 and 9 illustrate exemplary elementary streams for a video subdivided into tiles,

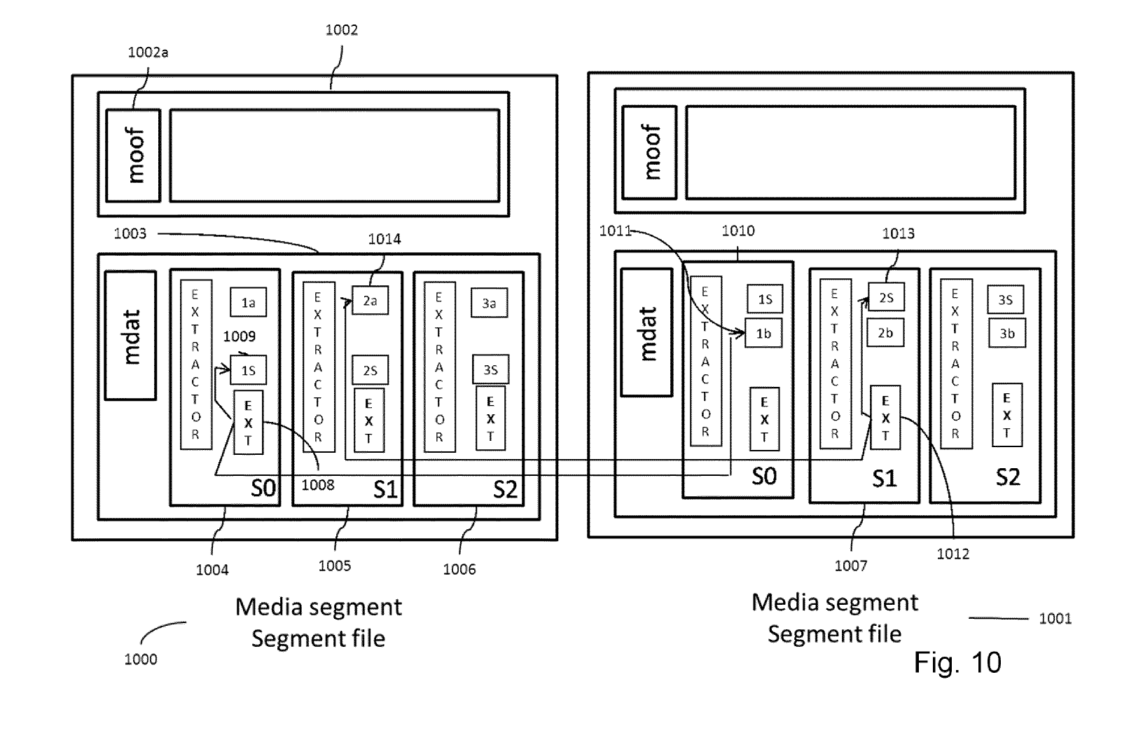

FIG. 10 illustrate multiple-extractors according to embodiments,

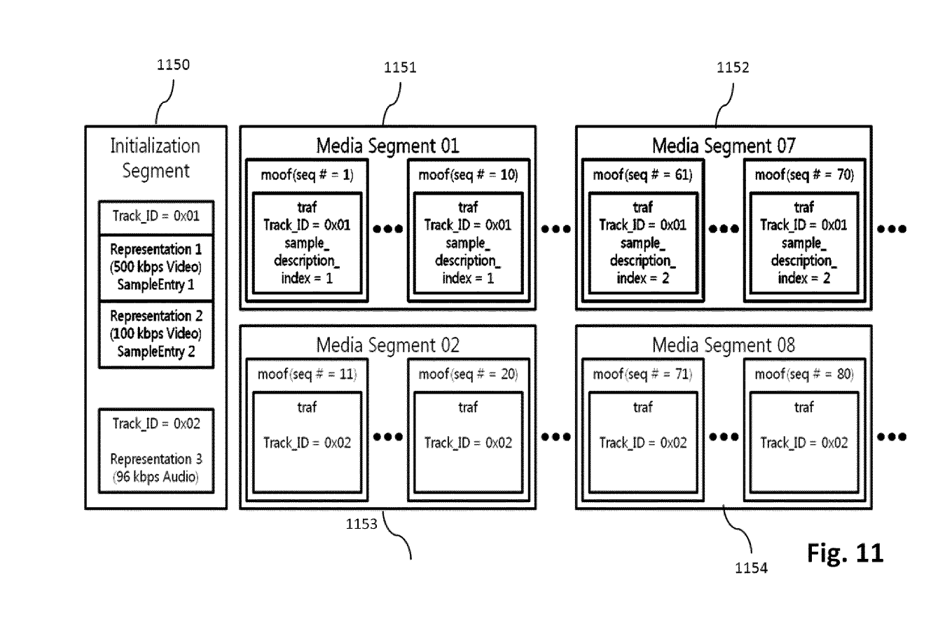

FIG. 11 illustrate segment files according to embodiments,

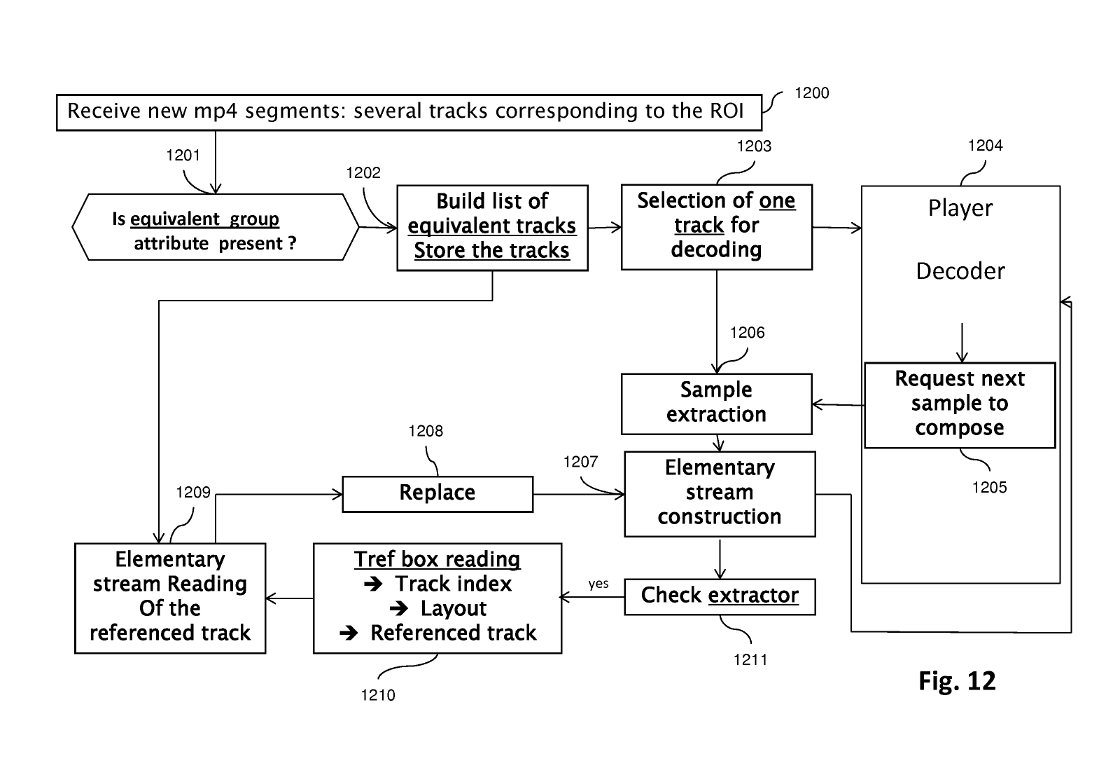

FIG. 12 illustrate an exemplary implementation of the display of a ROI according to embodiments,

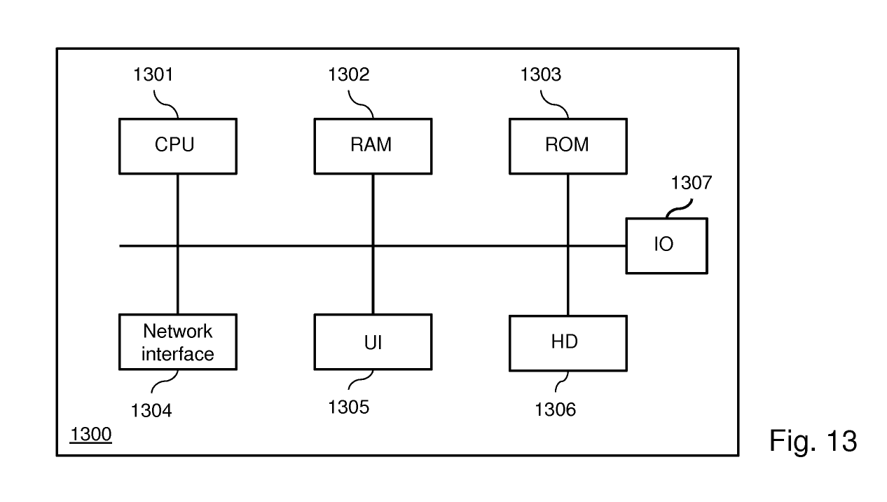

FIG. 13 is a schematic illustration of a device according to embodiments, and

Annexes A, B, C, D and E illustrate file formats according to embodiments.

In what follows, a general context of implementation of embodiments of the invention is first presented. Next, more specific details of implementation are described.

FIG. 3a is an illustration of the generation of an encapsulation file according to embodiments.

A source device 300 generates a video stream 301. The source device may be a video camera, a playback device or another kind of video source device. The video stream is received by an encoding device 302.

The encoding device subdivides the video stream received, according to a subdivision grid, during a step 303. Each image (or frame) of the video stream received is subdivided according to said same subdivision grid into image potions. Alternatively, the encoding device may receive a video stream already subdivided.

Next, during a step 304, a plurality of video streams are encoded, based on the subdivided video stream. In each encoded video stream, at least one image portion of the grid is encoded with a higher quality than the other image portions. In all frames of a same encoded video stream, the image portions encoded with higher quality all have the same position in the grid.

Once the video stream received is encoded as a plurality of encoded video streams, the encoded video streams are encapsulated into an encapsulation file 305 during a step 306.

The encapsulation file is subsequently transmitted to a server device 307, in order to be stored during a step 308.

One or several devices presented with reference to FIG. 3a may belong to a same device or system. Also, one or several devices presented with reference to FIG. 3a may belong to a server or a device dedicated to encapsulation.

FIG. 3b is an illustration of the use of the encapsulation file according to embodiments.

A client device 309, such as a display device, sends a video request 310 to the server device. The video request relates to the video stream 301 encoded by the encoding device 302.

The server device identifies the video stream and accesses the corresponding encapsulation file 305 during a step 311. The server device then starts streaming of the video by transmitting to the client device segment files 312. The segments files are subdivisions of the encapsulation file as described in the ISO BMFF standard. The segment files can be concatenated so as obtain a file compliant ISO BMFF format.

Based on the segment files received from the server device, the client device decodes the video stream during step 313 leading to the generation of a video signal 314, in order to be displayed on a screen.

During display of the video signal, appears the need for having a region of interest in the video signal displayed with higher quality. For example, a user identifies such region of interest and requests display with high quality.

A request 315 is transmitted from the client device to the server device. The request comprises an identification of the region of interest.

Upon receipt of the request, the server device identifies the region of interest and, during a step 316, it accesses the encapsulation file in order to determine, during a step 317, image portions of the grid that correspond to the region of interest.

The encoded video streams corresponding to the image portions determined are then transmitted to the client device through segment files 318.

Upon receipt of the segment files, the client combines the video streams during a step 319 in order to generate an encoded video stream, wherein the region of interest is encoded with higher quality than the other parts of the images. In 320, the encoded video stream is decoded leading to the generation of a video signal 321. The client device uses this video signal for displaying the video stream according to the request, i.e. with the region of interest displayed with high quality.

Encoding according to embodiments is described with reference to FIG. 4a. An initial video stream 400 is encoded and encapsulated in order to make it possible for the user to select a region of interest (ROI) in the video stream and have the ROI displayed with a higher quality than the remainder of the video stream.

Each image (or “frame” hereinafter) of the video stream 400 is subdivided into image portions (or “tiles” hereinafter) 401. For example, in FIG. 4a, each image is subdivided according to a rectangular grid of 2 by 4 squares. The grid has four upper tiles T1, T2, T3, T4 and four lower tiles T5, T6, T7, T8. The grid is common to the frames of the video stream. However, the embodiments of the invention are not limited to the grid presented in FIG. 4a. Other designs of the grid may be envisaged like for instance irregular grids with different size of tiles.

Once the initial video stream is subdivided according to the grid, a plurality of encoded video streams 402, 403 are generated. Each encoded video stream generated has in each frame an image portion encoded with a higher quality than the other image portions. For example, in encoded video stream 402, the frames have tile T1 encoded with a higher quality than the other tiles T2-T8. In encoded video stream 403, the frames have tile T8 encoded with a higher quality than the other tiles T1-T7. A plurality of encoded video streams is obtained wherein each tile T1-T8 is encoded with high quality in at least one encoded video stream. Although this is not represented in FIG. 4a, one, two or more tiles may be encoded with high quality in a same encoded video stream.

The encoded video streams are thereafter encapsulated into an encapsulation file. The encapsulation file may be a media presentation having as many video tracks as encoded video streams. We recall that a video track contains the encapsulation boxes related to an encoded video.

Display and streaming according to embodiments is described with reference to FIG. 4b. In the example illustrated in FIG. 4b, the initial video stream 400 has been subdivided into 16 tiles (numbered 1 to 16), according to a rectangular grid 404 of 4 by 4 rectangles.

An ROI 406 is defined, for example by a user, in order to have it displayed with a higher quality than the remainder of the video streams. In the example of FIG. 4b, the ROI extends over four tiles (1, 2, 5 and 6). Thus, four encapsulated encoded video streams are selected wherein the tiles (1, 2, 5 and 6) are (respectively) encoded with high quality.

The selected encapsulated encoded video streams are combined and then decoded to display frames wherein the ROI has a higher resolution than the remainder of the frame.

In what follows, encapsulation is described with more details with reference to FIG. 5a and FIG. 5b. An initial non-scalable video stream 500 is considered. The initial video stream is subdivided into four tiles “a”, “b”, “c” and “d”, according to a 2 by 2 rectangles grid 501 (represented here in perspective).

During encoding 502, five encoded video streams (“elementary streams” hereinafter) 503, 504, 505, 506 and 507 are generated from the initial video stream. Each tile of the grid has been encoded with a higher quality in a respective encoded video stream. Since the grid has four tiles and five elementary streams are generated, one of the elementary streams (503) is wholly encoded with low quality. This elementary stream (503) may be used by a client device to display the video with low quality.

Elementary streams are illustrated in more details in FIG. 5b. All tiles “a”, “b”, “c” and “d” in elementary stream 503 are encoded with basic or low quality (LQ). In elementary stream 504, tile “a” is encoded with high quality (HD), whereas the other tiles have been encoded with low quality. In elementary stream 505 (not represented), tile “b” is encoded with high quality (HD), whereas the other tiles have been encoded with low quality. In elementary stream 506 (not represented), tile “c” is encoded with high quality (HD), whereas the other tiles have been encoded with low quality. In elementary stream 507, tile “d” is encoded with high quality (HD), whereas the other tiles have been encoded with low quality.

Once all the elementary streams are generated, they are encapsulated into an encapsulation file 508 (“encapsulation format” hereinafter). ISO Base Media File Format and its extensions may be used. However, other formats may be used.

The encapsulation file comprises several video tracks respectively corresponding to the generated elementary streams. The file is a media presentation. Video tracks 509 (“Track 0”), 510 (“Track 1”), 511 (“Track 2”), 512 (“Track 3”), 513 (“Track 4”) respectively correspond to encapsulated elementary streams 503, 504, 505, 506, 507.

The ISO BMFF and the extension for DASH make it possible to put each track in different segment files. In such case, an initialization segment is generated. DASH is defined in documents “ISO/IEC 23009-1, Dynamic adaptive streaming over HTTP (DASH), Part1: Media presentation description and segment formats”, “ISO/IEC 14496-12:2008, Information technology—Coding of audio-visual objects—Part 12: ISO base media file format” and “ISO/IEC 14496-12:2008/FPDAM 3 & ISO/IEC 14496-12:2008/FDAM 3—Coding of audio-visual objects—Part 12: ISO base media file format, AMENDEMENT 3: DASH support and RTP”).

The initialization segment contains data defining and initializing the tracks. The initialization segment is associated with segment files. Each video track may be put in a respective segment file. Therefore, each track may be streamed independently. Based on these segment files, only the video tracks (and thus the segment files) useful for the end user can be sent.

Encapsulation is described with reference to FIG. 6a and FIG. 6b, with an initial video stream 600. The encapsulation is similar to the encapsulation described with reference to FIGS. 5a and 5b, but the video codec used is a scalable video codec. For example, the SVC video codec or the scalable extension of HEVC codec may be used.

The initial video stream is subdivided into four tiles “a”, “b”, “c” and “d”, according to a 2 by 2 rectangles grid 601.

During encoding 602, four encoded video streams (“elementary streams” hereinafter) 603, 604, 605, and 606 are generated from the initial video stream. Each tile of the grid has been encoded with a higher quality in a respective encoded video stream. Since a scalable video codec is used, each elementary stream contains NAL units (acronym for Network Abstraction Layer) corresponding to the base layer and NAL units corresponding to the enhancement layer.

Elementary streams are illustrated in more details in FIG. 6b. The enhancement layers of the elementary streams differ from one to another because each one contains a different respective tile encoded with high quality tile. In elementary stream 603, tile “a” is encoded with high quality (HD), whereas the other tiles have been encoded with low quality. In elementary stream 604, tile “b” is encoded with high quality (HD), whereas the other tiles have been encoded with low quality. In elementary stream 605 (not represented), tile “c” is encoded with high quality (HD), whereas the other tiles have been encoded with low quality. In elementary stream 606, tile “d” is encoded with high quality (HD), whereas the other tiles have been encoded with low quality.

The elementary streams 603, 604, 606 comprise respective base layers 607, 608, 609. Elementary stream 605 also comprises a base layer (not represented). The base layer is actually the same for all the elementary streams.

Once the elementary streams have been generated, they are encapsulated into an encapsulation file 610 (“file format” hereinafter). The ISO Base Media File Format and its extensions may be used. However, other formats may be used.

The encapsulation file comprises several video tracks respectively corresponding to the generated elementary streams for the enhancement layer. The encapsulation file also comprises a video track corresponding to the base layer. Since all the elementary streams share the same base layer, it is possible to create a video track containing the NAL units of the base layer. The file is a media presentation. Video tracks 611 (“Track 0”) correspond to the base layer and video tracks 612 (“Track 1”), 613 (“Track 2”), 614 (“Track 3”), 615 (“Track 4”) respectively correspond to encapsulated elementary streams 603, 604, 605, 606. In order to reduce redundancy, extractors (NALU), which are described in what follows with reference to Annex C, may be used. Extractors are specific NAL units that make it possible to point to other NALU in other external tracks. Thus, the video tracks (612, 613, 614 and 615) may be video tracks containing extractors pointing to track 611. The extractors are replaced during de-encapsulation by the NAL units of the base layer.

The ISO BMFF and the extension for DASH make it possible to put each track in different segment files. In such case, an initialization segment is generated. The initialization segment contains data defining and initializing the tracks. The initialization segment is associated with segment files. Each video track may be put in a respective segment file. Therefore, each track may be streamed independently. Based on these segment files, only the video tracks (and thus the segment files) useful for the end user can be sent.

FIGS. 7a and 7b illustrate the use of video tracks as presented above with reference to FIGS. 6a and 6b, for displaying a ROI with high resolution. FIG. 7b focuses on the decoding of the track at a client side.

A region of interest (ROI) is defined in frames of a video stream 700. The frames of the video stream are subdivided according to a subdivision grid. In the example of FIGS. 7a and 7b, the subdivision grid has four tiles a, b, c and d.

The ROI may be defined by a user. It may also be defined automatically. In the example of FIGS. 7a and 7b, the ROI extends over tiles a and b.

As explained above, elementary video streams are generated. In FIGS. 7a and 7b, only the elementary video streams relating to the ROI are represented. A first elementary stream 701 has tile a encoded with high quality (HQ), i.e. high resolution, while the other tiles are encoded with low quality (LQ), i.e. low resolution. A second elementary 702 has tile b encoded with high quality (HQ), i.e. high resolution, while the other tiles are encoded with low quality (LQ), i.e. low resolution.

For example, the elementary streams are scalable. In such case, a base layer is associated with each elementary stream.

Based on the elementary streams, three video tracks are generated and sent to the client device. Track 703 (“Track 0”) corresponds to the base layer. Track 704 (“Track 1”) corresponds to the base and enhancement layer of elementary stream 701. Track 705 (“Track 2”) corresponds to the base and enhancement layer of elementary stream 702. Tracks 704 and 705 may contain extractors pointing to the Track 0.

The client device receives the tracks within an encapsulation file and extracts and combines them during a step 706. The combination is based on the multiple extractors proposed in this invention and is explained in the FIG. 12. From these operations of extraction and combination, one single elementary stream is obtained. This elementary stream is then decoded during a step 707, to display a video stream 708 wherein the ROI has a higher resolution than the remainder of the frames of the video stream.

FIG. 8 illustrates with more details an exemplary elementary stream for a video subdivided into tiles. Three frames 800 (Frame 1), 801 (Frame 2) and 802 (Frame 3) of the elementary video stream are represented. Each frame is subdivided according to a subdivision grid of four tiles a, b, c and d. For example, the frames are encoded with a scalable video codec. Thus the elementary stream comprises NAL units (NALU) 803.

The NALU are organized according to the decoding order. The NAL units (1BL, 1a, 1b, 1c, 1d) of the first frame 800 are first. The NAL units (2BL, 2a, 2b, 2c, 2d) of the second frame 801 come after the NAL unit of the first frame. The NAL units (3BL, 3a, 3b, 3c, 3d) of the third frame 802 come after the NAL unit of the first frame.

The NAL units corresponding to a same tile are named with the letter corresponding to the tile (a, b, c, d). The NALUs corresponding to the base layer are named with “BL”.

FIG. 9 is an illustration of four elementary streams 900 generated according to the principles described with reference to FIG. 8.

The NAL units of a first elementary stream 901 (“Elementary Stream 1”) are disposed in decoding order (Frame 1 to Frame 3). First the NAL units of the base layer (BL) are shown. Next, the NAL units of tile a are shown. Because these NAL units are the NAL units encoded with a high quality, the notation ‘1a’ for these NALU is used. For the other tiles of the frame, for which the NAL units are encoded with low quality, the notation ‘1s’ is used. The same notations are used for the second frame (2BL, 2a, 2s) and the third frame (3BL, 3a, 3s).

The other elementary streams 902 (“Elementary Stream 2”), 903 (“Elementary Stream 3”) and 904 (“Elementary Stream 4”) are represented according to the same principles. In each elementary stream, for the sake of conciseness, only the tile encoded with high quality is represented, the other tiles being represented under the notations 1s, 2s, 3s.

The elementary streams are then encapsulated during a step 905 into a file format, thereby obtaining a Media file 906.

For example, the media file is compatible with the ISO BMFF file format standard.

When using the ISO BMFF reference file format, modifications of the file format may be envisaged. Modifications are presented with reference to Annex A and Annex B.

Annex A is the code for the track header box in the current version of the file format defined in document “ISO/IEC 14496-12, Information technology—Coding of audio-visual objects—Part 12: ISO base media file format”. The file format is an encapsulation format that describes the elementary streams of the tracks comprised in a media presentation. The file format has tools for composing the tracks. The track box contains several other boxes. One of the boxes is the track header box. This box, shown in Annex A, contains several attributes described in document “ISO/IEC 14496-12, Information technology—Coding of audio-visual objects—Part 12: ISO base media file format”.

Annex B shows modification that may be made in the track header box discussed hereinabove. An attribute “equivalent_group” is added in the track header box. This attribute defines a relation with other tracks of the same media presentation. This new attribute may be an integer that specifies a group (or collection) of tracks. If the value of the attribute is set to “0”, this may be interpreted as there is no equivalence relation with other tracks. If the value of the attribute is not set to “0”, this is interpreted as the track is related to all the other tracks having the attribute set to the same value.

In other words, tracks of a media representation having the equivalent_group attribute set to the same value are considered as related and thus defining an equivalent data group. More specifically, they can be considered as equivalent. Therefore, it is possible to select one of the tracks (of the group of those sharing the same “equivalent_group” attribute value) and to extract the elementary stream of the selected track. Another name for this “equivalent_group” can be the “group data portion”. The obtained elementary stream is equivalent to the one that would have been obtained by selecting any other track in this group. The resulting elementary stream may also be enhanced with a tile with high quality replacing a tile with low quality.

This ‘equivalence’ property is possible by the introduction of new kind of extractors described hereinafter. In particular, the way the equivalence attribute may be used is explained with reference to FIG. 12.

The new extractors used for implementing the equivalence property are described with reference to FIG. 10. The extractors may be referred to as “multiple-extractor”. The multiple extractors are to be distinguished from the extractors (referred to as “standard extractors”) described in document “ISO/IEC 14496-15:2010—2^{nd} edition—Information technology—Coding of audio-visual objects—Part 15: Advanced Video Coding (AVC) file format”.

Standard extractors are represented by boxes labeled “EXTRACTOR”. These extractors are in-stream structures using a NAL unit header including a NAL unit header SVC extension, with a NAL unit type set to “31”. Standard extractors contain instructions on how to extract data from other tracks. Logically a standard extractor can be seen as a ‘link’. While accessing a track containing standard extractors, the standard extractor is replaced by the data it is referencing.

The syntax of a standard extractor is shown in Annex C.

NALUnitHeader( ) is the NAL unit structure as specified in document “ISO/IEC 14496-15:2010 Information technology—Coding of audio-visual objects—Part 15:Advanced Video Coding file format.

“nal_unit_type” shall be set to the extractor NAL unit type (i.e. type 31).

“forbidden_zero_bit”, “reserved_one_bit”, and “reserved_three_{—}2 bits” shall be set as specified in above document “ISO/IEC 14496-15”.

Other fields like “nal_ref_idc”, “idr_flag”, “priority_id”, “no_inter_layer_pred_flag”, “dependency_id”, “quality_id”, “temporal_id”, “use_ref_base_pic_flag”, “discardable_flag”, and “output_flag” shall be set as specified in section B.4 of above of “ISO/IEC 14496-15” document.

In Annex C, “track_ref_index” parameter represents the index of the track reference of type ‘scal’ to use to find the track from which to extract data. The sample in that track from which data is extracted is temporally aligned in the media decoding timeline (i.e. using the time-to-sample table only), adjusted by an offset specified by the “sample_offset” parameter with the sample containing the extractor. The first track reference has the index value “1”; the value “0” is reserved.

Parameter “sample_offset” gives the relative index of the sample in the linked track that shall be used as the source of information. Sample 0 (zero) is the sample with the same, or the closest preceding, decoding time compared to the decoding time of the sample containing the extractor; sample 1 (one) is the next sample, sample −1 (minus 1) is the previous sample, and so on.

Parameter “data_offset” represents the offset of the first byte within the reference sample to copy. If the extraction starts with the first byte of data in that sample, the offset takes the value “0”. The offset shall reference the beginning of a NAL unit length field.

Parameter “data_length” represents the number of bytes to copy. If this field takes the value “0”, then the entire single referenced NAL unit is copied (i.e. the length to copy is taken from the length field referenced by the data offset, augmented by the additional_bytes field in the case of Aggregators).

Back to FIG. 10, multiple-extractors are represented by boxes labeled “EXT”. The multiple-extractors are in-stream structures using NAL unit header including a NAL unit header SVC extension with a NAL unit type set to a value between “48” and “63”. These values can be used, since for example in the AVC standard, they are not attributed. Multiple-extractors contain instructions on how to replace data from the current track with data from other tracks. Logically a multiple-extractor can be seen as a ‘link’. While accessing a track containing multiple-extractors, once the replacement data is conducted, the multiple-extractor may be deleted.

The syntax of multiple-extractors is shown in Annex D. The multiple-extractors comprise several attributes.

NALUnitHeader( ) is the NAL unit structure as described in document “ISO/IEC 14496-15:2010”.

Parameter “nal_unit_type” shall be set to the extractor NAL unit type. The type may be between ‘48’ and ‘63’.

Parameters “forbidden_zero_bit”, “reserved_one_bit”, and “reserved_three_{—}2bits” shall be set as specified in document “ISO/IEC 14496-15:2010”.

Other fields like “nal_ref_idc”, “idr_flag”, “priority_id”, “no_inter_layer_pred_flag”, “dependency_id”, “quality_id”, “temporal_id”, “use_ref_base_pic_flag”, “discardable_flag”, and “output_flag” shall be set as specified in section B.4 of ISO/IEC 14496-15:2010. The values associated to these fields should correspond to the NALU of the external track to which the multiple-extractor points.

Parameter “track_ref_index” represents the index of the track reference of type ‘tile’ and described below to use to find the track from which to extract data. The sample in that track from which data is extracted is temporally aligned in the media decoding timeline (i.e. using the time-to-sample table only), adjusted by an offset specified by the “sample_offset” parameter with the sample containing the extractor. The first track reference has the index value “1”; the value “0” is reserved.

A definition of a new type ‘tile’ for the track reference index may be needed. Since, the external tracks are not directly referenced; the track reference box (called the ‘tref’ box in the ISO BMFF standard) is used as intermediate box. The track reference index is a link pointing to an index in the ‘tref’ box. This index provides the external track identifier. This identifier is of a given type. With the definition of a new kind of extractors (the multiple-extractors), a new type may be introduced for the ‘tref’ box. This new type may be referred to as the ‘tile’ type.

Parameter “sample_offset” gives the relative index of the sample in the linked track that shall be used as the source of information. Sample 0 (zero) is the sample with the same, or the closest preceding, decoding time compared to the decoding time of the sample containing the extractor; sample 1 (one) is the next sample, sample −1 (minus 1) is the previous sample, and so on.

Parameter “data_offset” represents the offset of the first byte within the reference sample to copy. If the extraction starts with the first byte of data in that sample, the offset takes the value “0”. The offset shall reference the beginning of a NAL unit length field.

Parameter “data_length” represents the number of bytes to copy. If this field takes the value “0”, then the entire single referenced NAL unit is copied (i.e. the length to copy is taken from the length field referenced by the data offset, augmented by the additional_bytes field in the case of Aggregators).

The syntax of Annex D also differs from the syntax of Annex C by the following parameters:
“nb_reference”: represents the number of sub-parts of the elementary stream in the internal tracks that can be replaced by sub-parts of the elementary stream in external tracks. For each of these references, the following data are written.
“local_data_offset”: represents the offset of the first byte within the current sample to replace. If the replacement starts with the first byte of data in the current sample, the offset takes the value 0. The offset shall reference the beginning of a NAL unit length field.
“local_data_length”: The number of bytes to replace. If this field takes the value 0, then the entire single referenced NAL unit is copied (i.e. the length to copy is taken from the length field referenced by the data local offset, augmented by the additional_bytes field in the case of Aggregators).

Therefore, parameter “nb_reference” makes it possible to specify several parts of the elementary stream. Parameters “local_data_length”, “local_data_offset” make it possible to specify an internal part of the elementary stream as replacement area.

Annex E shows an alternate syntax for the multiple extractors.

This alternate syntax may be used in case several external tracks can be used as replacement elementary stream for a same sub-part of the elementary stream in the current internal track.

Therefore, the multiple-extractor comprises several attributes for addressing this case in addition to those already presented with reference to Annex D.

Parameter “nb_tracks”: represents the number of tracks that could be used for replacing the internal data defined by the couple (local_data_offset, local_data_length). Several external candidate tracks could be used for replacing the elementary stream of the internal track.

For example, a same tile can be encoded with a medium quality, good quality and high quality in three different elementary streams (the remaining tiles being encoded with a basic quality). These elementary streams could be included in different external tracks and the parameter nb_tracks could identify the number of tracks.

Parameter “layer” represents a relevance layer for the current track. Priority given to a track to serve as replacement data may be a function of the value of this parameter. This attribute is interesting for selecting the track with the better quality replacement data when several tracks can be used.

Back to the exemplary context of FIG. 10, the initial video is split into two tiles a and b (instead of 4 as illustrated in the previous examples and figures). Three elementary streams are generated, for example using a scalable video codec such as SVC. For example, the media presentation is split into segment files. For the sake of conciseness, the initialization segment and the segment containing the base layer are not represented. In particular the initialization segment contains the track boxes. The segments 1000 and 1001 displayed in FIG. 10 relate to the same period of time. Other media segment may relate to other periods of time.

The first video track (“Track 1”, not represented) contains the elementary stream related to the base layer (the term ‘track’ may be used even if “traf” boxes (from ISO/IEC 14496-15:2010) are used in segment files containing fragments). This first video track can either be decoded alone or can be used as a reference track for other tracks containing both extractors and enhancement layers. Standard extractors in the SVC context (base layer and enhanced layer) are described in document “P. Amon, T. Rathgen and D. Singer, File Format for Scalable Video Coding, IEEE transactions on circuits and systems for Video technology, Vol. 17, No. 9, September 2007”.

The other tracks are put in a different segment file. The second video track 1002 (“Track 2”) is embedded in the first segment file 1000. The third video track (“Track 3”) is embedded in the segment file 1001.

For example, let Track 2 be the reference. The corresponding segment file comprises a movie fragment and the related elementary stream put in the ‘mdat’ box 1003. The movie fragment box 1002a (“moof box”) contains the metadata describing the elementary stream. Boxes related to a fragment are described in document “ISO/IEC 14496-12, Information technology—Coding of audio-visual objects—Part 12: ISO base media file format”.

The ‘mdat’ box 1003 contains the different NALU of the elementary stream. Track 2 is an enhancement layer. Therefore, it contains the NALU related to the base layer and the NALU related to the enhanced layer. For avoiding the duplication of the base layer NALU, standard extractors (“EXTRACTORS”) are used (standard extractors are described in more details with reference to annex C).

In the example of FIG. 10, the segment files contain three frames. According to the ISO BMFF standard vocabulary, a frame is referred to as a “sample”. For example, elements 1004 (“S0”), 1005 (“S1”) and 1006 (“S2”) of FIG. 10 comprise the NALU related to three consecutive samples (or frames) of the media segment. For example, in sample 1004 (S0) of Track 2, element ‘1a’ represents the NALU related to the high quality tile a, whereas element ‘1s’ represents the NALU related to the low quality tile b. In sample 1007 (S1) of Track 3, element ‘2s’ represents the NALU related to the low quality tile a, and element ‘2b’ represents the NALU related to the high quality tile ‘b’.

The multiple-extractors (“EXTRACTOR”) in the samples S0, S1, S2 of the video tracks are specific NALU that may be added in the elementary stream during the file format encapsulation. The multiple-extractors may be added in each sample (or frame) of the elementary streams.

Multiple-extractors contain data that make it possible to:
point to several parts of several elementary streams (to the track wherein the multiple-extractor is located and/or to external tracks), and/or
replace one part of the elementary stream with another part of the elementary stream.

In other words, the multiple-extractors link at least:
the elementary stream related to the track wherein the extractor is comprised (for example multiple-extractor 1008 points to NALU ‘1s’ 1009), and
the elementary stream related to an external track (for example, extractor 1008 points to NALU 1011 (‘1b’) of external Track 3.

The NALU corresponding to a low quality tile in sample S0 of Track 2 1009 and the NALU corresponding to a high quality tile ‘1b’ in sample S0 of Track 3 1011 both describe the same spatial part of frame ‘S0’. When the multiple-extractor is read (for example during the extraction of the elementary stream at the client side), the multiple-extractor replaces the part within the elementary stream to which it points with the external part of the elementary to which it points. For example, when multiple-extractor 1008 is read, NALU ‘1s’ 1009 are replaced by NALU ‘1b’ 1011. Therefore, low quality tile ‘b’ of frame ‘S0’ is replaced by high quality tile ‘b’ of the same frame ‘S0’. Once the replacement is performed, the multiple-extractor may be removed. The elementary stream transmitted to the decoder is then compliant with the standard codec.

If Track 3 is not streamed and received, there is no replacement data available. In this case, the multiple-extractor may be removed.

With multiple-extractors as described above, when only the segment files related to high quality tile ‘a’ are streamed, the decoded video contains only tile ‘a’ with high quality whereas the other tiles are at the basic (or low) quality. If the ROI extends over several tiles, the segment files related to these high quality tiles can be ‘merged’ in a unique elementary stream wherein the ROI tiles are encoded with a high quality. The high quality ROI can therefore be constructed by streaming the segment files containing each tile over which the ROI extends and combining them.

In FIG. 10, multiple-extractor 1012 points to:
the internal elementary stream ‘2s’ 1013 and
the external elementary stream ‘2a’ 1014.

If the two media segments are received, the low quality data 1013 can be replaced by the high quality data 1014. The resulting elementary stream is an elementary stream wherein tiles ‘a’ and ‘b’ are of high quality. In case only segment file 1001 is received, only tile ‘b’ is of high quality.

In case media segments 1000 and 1001 are received, decoding each one of these two media segments leads to equivalent results. Thus, the decoding of both media segments may be redundant. The use of the ‘equivalent_group’ attribute discussed with reference to Annex B makes it possible to avoid such redundancy. In case Track 2 and Track 3 have the ‘equivalent_group’ attribute set to a same value, they are equivalent, and the file format reader may take into consideration this fact and can read only one of these two segments.

In the above description of the multiple-extractors, one multiple-extractor is embedded inside each sample. However, it may be possible to embed several multiple-extractors.

The segment files (or media segments) are more specifically described with reference to FIG. 11. The ISO BMFF and the extensions for DASH make it possible to split a media presentation into autonomous fragments. Each fragment corresponds to a respective period of time. A fragment comprises at least a “movie fragment box” and a “media data box”. The media data box contains the elementary stream corresponding to the period of time of the fragment. The movie fragment box contains the metadata data corresponding to the elementary stream. Fragments corresponding to a same track can be grouped together in a same media segment (or segment file). This is illustrated in FIG. 11. Two tracks are defined. The first track is a video track with the “track_ID” data equal to 0x01 (with two representations), the second track is an audio track with “track_ID “equal to 0x02.

The two tracks are initially defined in an initialization segment 1150. For example, the initialization segment contains a definition of each track (track box, track header box etc.) and the composition information of the different tracks (still in the track boxes). A set of segment files 1151, 1152, 1153 and 1154 can be defined. Media segment 1151 contains fragments corresponding to the first track on a first period of time. Media segment 1152 contains fragments related to the same first track but for a second period of time. These fragments then correspond to a different period of time. Media segment 1153 contains fragments related to the second track. Media segment 1154 contains fragments related to the same second track. Fragment 1153 corresponds to a period of time different from the one associated with fragment 1154. These media segments can be streamed separately and concatenated together with an initialization segment. The resulting media presentation is compatible with the ISO BMFF file format standard.

FIG. 12 is an illustration of an exemplary implementation of the display of a ROI according to embodiments. The illustration focuses on the client side. It is assumed that an initialization segment and media segments (such as MP4 segments) are received. For example, the initialization segment comprises the metadata describing video streams. Some media segments contain the base layer data. Other received media segments comprise high quality versions of the tiles of a video stream over which the ROI to display with high quality extends. The Segments are received during a step 1200.

During a step 1201, the initialization segment is read. This segment contains the track boxes of the different tracks. The reader searches in the track header boxes which ones are equivalent. Next, during a step 1202, it builds the list of segment files (one segment file is associated to a track) that are equivalent (the list of tracks that can be considered as equivalent). The segment files corresponding to a same period of time are grouped together. One of these equivalent tracks is selected during step 1203.

The client device 1204, which is in charge of playing the video, needs the frames of the elementary stream. Therefore, a decoder module of the client device requests during a step 1205 the next sample to decode.

Based on the request, the NALU of the required sample are extracted during a step 1206 for constructing an elementary stream. If the extracted elementary stream does not contain extractors (either standard extractors or multiple-extractors) the elementary stream can be directly given to the decoder. If the extracted elementary stream contains extractors the elementary stream is constructed (step 1207) by resolving the extractors as described below.

During a step 1211, the presence of extractors is checked. If extractors are present (yes), the extractor is read and is resolved. Only resolution of a multiple-extractor is addressed in this figure since resolution of standard extractors is known to the skilled person.
The data related to the extractors are read during a step 1210 during which the data to replace in the internal track are localized using the parameters ‘local_data_offsey’ and ‘local_data_length’, the external track is identified by reading the ‘track_ref_index’ and the data in the ‘tref’ box to which points the ‘track_ref_index’, and the replacement data are localized from the reading of the parameters ‘sample_offset’, ‘data_offset’ and ‘data_length’.

Next, extraction of the replacement data is performed during a step 1209 by having access to the media files stored (during step 1202)

The data replacement is performed during a step 1208.

Once the replacement is conducted, the multiple-extractor is removed.

If no external track exists, the multiple-extractor is removed.

Once these operations are conducted for all the extractors, the elementary stream can be given to the decoder.

Only the media segments that contain the high quality version of the tiles composing the ROI need to be sent from the server to the client.

FIG. 13 is a schematic block diagram of a computing device 1300 for implementation of one or more embodiments of the invention. The computing device 1300 may be a device such as a micro-computer, a workstation or a portable device. The computing device 1300 comprises a communication bus connected to:
a central processing unit 1301 (CPU), such as a microprocessor;
a random access memory 1302 (RAM), for storing the executable code of methods according to embodiments of the invention and/or register for variables and parameters used for implementation of the methods;
a read only memory 1303 (ROM), for storing computer programs for implementing embodiments of the invention;
   a network interface 1304 connected to a communication network over which digital data to be processed are transmitted or received. The network interface 1304 can be a single network interface, or composed of a set of different network interfaces (for instance wired and/or wireless interfaces. Data transmission may be controlled by a software application executed by the CPU;
a user interface 1305 for receiving inputs from a user or to display information to a user;
a hard disk 1306 (HD);
   an I/O module 1307 for receiving/sending data from/to external devices such as a video source or display.

The executable code may be stored either in read only memory 1303, on the hard disk 1306 or on a removable digital medium such as disk. The executable code of the programs may also be received by means of a communication network, via the network interface 1304, in order to be stored in one of the storage means of the communication device 1300, such as the hard disk 1306, before being executed.

The central processing unit 1301 is configured for controlling execution of the instructions or portions of software code of the program or programs according to embodiments of the invention, which instructions are stored in one of the aforementioned storage means. The CPU 1301 may execute instructions from the RAM memory after the instructions have been loaded from the ROM memory or the hard-disc (HD) for example. Such software application, when executed by the CPU 1301, causes the steps of methods according to embodiments.

A computer program according to embodiments may be designed based on the flowcharts of FIGS. 3a, 3b, 12, Annexes A, B, C, D, E and the present description.

Such computer program may be stored in a ROM memory of a system or device as described with reference to FIG. 13. It may be loaded into and executed by a processor of such device for implementing steps of a method according to the invention.

Embodiments of the inventions may also be implemented in hardware (for example, in the form of an Application Specific Integrated Circuit or ASIC).

While the invention has been illustrated and described in detail in the drawings and foregoing description, such illustration and description are to be considered illustrative or exemplary and not restrictive, the invention being not restricted to the disclosed embodiment. Other variations to the disclosed embodiment can be understood and effected by those skilled in the art in practicing the claimed invention, from a study of the drawings, the disclosure and the appended claims.

In the claims, the word “comprising” does not exclude other elements or steps, and the indefinite article “a” or “an” does not exclude a plurality. A single processor or other unit may fulfill the functions of several items recited in the claims. The mere fact that different features are recited in mutually different dependent claims does not indicate that a combination of these features cannot be advantageously used. Any reference signs in the claims should not be construed as limiting the scope of the invention.

ANNEX A

```
aligned(8) class TrackHeaderBox extends FullBox(‘tkhd’, version, flags){
  if (version==1) {
    unsigned int(64) creation_time;
    unsigned int(64) modification_time;
    unsigned int(32) track_ID;
    const unsigned int(32) reserved = 0;
    unsigned int(64) duration;
  } else { // version==0
    unsigned int(32) creation_time;
    unsigned int(32) modification_time;
    unsigned int(32) track_ID;
    const unsigned int(32) reserved = 0;
    unsigned int(32) duration;
  }
  const unsigned int(32)[2] reserverd = 0;
  template int(16) layer = 0;
  template int(16) alternate_group = 0;
  template int(16) volume = {if track_is_audio 0x0100 else 0};
  const unsigned int(16) reserved = 0;
  template int(32)[9] matrix= {
0x00010000,0,0,0,0x00010000,0,0,0,0x40000000 }; // unity matrix
  unsigned int(32) width;
  unsigned int(32) height;
}
```

ANNEX B

```
aligned(8) class TrackHeaderBox extends FullBox(‘tkhd’, version, flags){
if (version==1) {
  unsigned int(64) creation_time;
  unsigned int(64) modification_time;
  unsigned int(32) track_ID;
  const unsigned int(32) reserved = 0;
  unsigned int(64) duration;
} else { // version==0
  unsigned int(32) creation_time;
  unsigned int(32) modification_time;
  unsigned int(32) track_ID;
  const unsigned int(32) reserved = 0;
  unsigned int(32) duration;
}
const unsigned int(32)[2] reserved = 0;
template int(16) layer = 0;
template int(16) alternate_group = 0;
template int(16) equivalent_group = 0;
template int(16) volume = {if track_is_audio 0x0100 else 0};
const unsigned int(16) reserved = 0;
template int(32)[9] matrix=
{ 0x00010000,0,0,0,0x00010000,0,0,0,0x40000000 };
// unity matrix
unsigned int(32) width;
unsigned int(32) height;
```

ANNEX C

```
class aligned(8) Extractor ( ) {
  NALUnitHeader( );
  unsigned int(8) track_ref_index;
  signed int(8) sample_offset;
  unsigned int((lengthSizeMinusOne+1)*8) data_offset;
  unsigned int((lengthSizeMinusOne+1)*8) data_length;
}
```

Annex D

```
class aligned(8) MultiExtractor ( ) {
  NALUnitHeader( );
  unsigned int nb_reference;
  for(unsigned int i=0 to nb_reference − 1){
    unsigned int((lengthSizeMinusOne+1)*8) local_data_offset;
    unsigned int((lengthSizeMinusOne+1)*8) local_data_length;
    unsigned int(8) track_ref_index;
    signed int(8) sample_offset;
    unsigned int((lengthSizeMinusOne+1)*8) data_offset;
    unsigned int((lengthSizeMinusOne+1)*8) data_length;
  }
}
```

Annex E

```
class aligned(8) MultiExtractor ( ) {
  NALUnitHeader( );
  unsigned int nb_reference;
  for(unsigned int i=0 to nb_reference − 1){
    unsigned int((lengthSizeMinusOne+1)*8) local_data_offset;
    unsigned int((lengthSizeMinusOne+1)*8) local_data_length;
    {
      unsigned int nb_tracks;
      for(unsigned int j=0 to nb_tracks − 1)
      {
        signed int(8) layer;
        unsigned int(8) track_ref_index;
        signed int(8) sample_offset;
        unsigned int((lengthSizeMinusOne+1)*8) data_offset;
        unsigned int((lengthSizeMinusOne+1)*8)
data_length;
      }
    }
  }
}
```

1. A method of processing a video stream for encapsulation into an encapsulation file, the method comprising including in at least one first encoded video stream of a plurality of encoded video streams, at least one link between:
first encoded image data in said at least one first encoded video stream, and
second encoded image data in at least one second encoded video stream of the plurality, and
wherein said at least one first and second encoded image data correspond to a same spatial area of the images of the first and second encoded video streams.

2. A method according to claim 1, wherein each encoded video stream comprises encoded images with at least one same respective image portion encoded with a higher resolution than the other image portions.

3. A method according to claim 2, wherein said first encoded image data is not encoded with a higher resolution in the first encoded video stream, and wherein said second encoded image data is encoded with a higher resolution in the second encoded video stream.

4. A method according to claim 2, wherein each one of the plurality of encoded video streams is encoded with a base layer with a low resolution and an enhancement layer with said images with at least one same respective image portion encoded with a higher resolution than the other image portions.

5. A method according to claim 4, wherein said base layer is the same for the plurality of encoded video streams.

6. A method according claim 1, wherein said first and at least one second image data belong to respective frames of the first and at least one second encoded video streams, said frames having a same temporal position in said encoded video streams.

7. A method according to claim 1, wherein each encoded video stream is encapsulated with a group data portion identifying a group of encoded video streams to which it belongs, each encoded video stream of the group being linked to another encoded video stream of the group.

8. A method according to claim 1, wherein each image of the encoded video streams of the plurality is subdivided into a plurality of image portions, wherein the images of the encoded video streams are subdivided according to a same subdivision grid, and wherein said at least one first and second encoded image data correspond to a same image portion of the grid.

9. A method according to claim 8, wherein said plurality of encoded video streams are encoded from a common subdivided video stream, wherein each image of said common subdivided video stream is subdivided into a plurality of image portions according to said same subdivision grid.

10. A method according to claim 9, further comprising encapsulating, into said encapsulation file, said common subdivided video stream encoded with a low resolution.

11. A method according to claim 8, wherein, said at least one second encoded image data is associated with a resolution level data indicating a level of resolution with which said at least one second encoded image data is encoded.

12. A method according to claim 11, wherein said resolution level data comprises a superimposition data indicating a position of the at least one second encoded image data in a superimposition of image data layers.

13. A method of processing an encapsulation file for displaying video data, the method comprising the following steps:
accessing an encapsulation file comprising a plurality of encapsulated encoded video streams,
identifying, in at least one first encoded video stream of the encapsulation file, at least one link between first encoded image data in said at least one first encoded video stream, and second encoded image data in at least one second encoded video stream of said plurality, wherein said at least one first and second encoded image data correspond to a same spatial area of the images of the first and second encoded video streams,
replacing, in said first encoded video stream, said first encoded image data with said second encoded image data,
decoding said first encoded video stream, and
generating a video signal based on video data obtained by said decoding.

14. A method according to claim 13, further comprising deleting, in said first encoded video stream, said link, once said substitution is performed.

15. A method according to claim 13, wherein each encapsulated encoded video stream comprises encoded images with at least one same respective image portion encoded with a higher resolution than the other image portions.

16. A method according to claim 15, wherein said first encoded image data is not encoded with a higher resolution in the first encoded video stream, and wherein said second encoded image data is encoded with a higher resolution in the second encoded video stream.

17. A method according to claim 15, wherein each one of the plurality of encoded video streams is encoded with a base layer with a low resolution and an enhancement layer with said images with at least one same respective image portion encoded with a higher resolution than the other image portions.

18. A method according to claim 17, wherein said base layer is the same for the plurality of encoded video streams.

19. A method according to claim 13, wherein said first and second image data belong to respective frames of the first and second encoded video streams, said frames having a same temporal position in said encoded video streams.

20. A method according to claim 13, wherein each encoded video stream is encoded with a group data portion identifying a group of encoded video streams to which it belongs, each encoded video stream of the group being linked to another encoded video stream of the group.

21. A method according to claim 20, further comprising selecting said first and at least one second encoded video streams as having respective group data portions identifying a same group of encoded video streams.

22. A method according to claim 13, wherein each image of the encoded video streams of the plurality is subdivided into a plurality of image portions, wherein the images of the video streams are subdivided according to a same subdivision grid, and wherein said at least one first and second encoded image data correspond to a same image portion of the grid.

23. A method according to claim 22, wherein said plurality of encoded video streams are encoded from a common subdivided video stream, wherein each image of said common subdivided video stream is subdivided into a plurality of image portions according to said same subdivision grid.

24. A method according to claim 23, wherein said encapsulation file comprises said common subdivided video stream encoded with a low resolution.

25. A method according to claim 22, wherein, said at least one second encoded image data is associated with a resolution level data indicating a level of resolution with which said at least one second encoded image data is encoded.

26. A method according to claim 25, wherein said resolution level data comprises a superimposition data indicating a position of the second encoded image data in a superimposition of image data layers and wherein the second encoded image data is displayed according to said position.

27. An image processing device for processing a video stream for encapsulation into an encapsulation file, the device comprising a processing unit configured for including in at least one first encoded video stream of a plurality of encoded video streams, at least one link between:
first encoded image data in said at least one first encoded video stream, and
second encoded image data in at least one second encoded video stream of the plurality, and
wherein said at least one first and second encoded image data correspond to a same spatial area of the images of the first and second encoded video streams.

28-61. (canceled)

62. An image processing device for processing an encapsulation file for displaying video data, the device comprising a processing unit configured for:
accessing an encapsulation file comprising a plurality of encapsulated encoded video streams,
identifying, in at least one first encoded video stream of the encapsulation file, at least one link between first encoded image data in said at least one first encoded video stream, and second encoded image data in at least one second encoded video stream of said plurality, wherein said at least one first and second encoded image data correspond to a same spatial area of the images of the first and second encoded video streams,
replacing, in said first encoded video stream, said first encoded image data with said second encoded image data,
decoding said first encoded video stream, and
generating a video signal based on video data obtained by said decoding.

63. A method of processing a video stream for encapsulation into an encapsulation file, the method comprising including in at least one first encoded video stream of a plurality of encoded video streams, at least one link between:
first information indicating a first spatial area of a frame included in said at least one first encoded video stream, and
second information indicating a second spatial area of a frame included in at least one second encoded video stream of the plurality of encoded video streams, and
wherein said first information and said second information indicate a corresponding spatial area on a frame.

64. A device for processing a video stream for encapsulation into an encapsulation file, the device comprising a processing unit configured for including in at least one first encoded video stream of a plurality of encoded video streams, at least one link between:
first information indicating a first spatial area of a frame included in said at least one first encoded video stream, and
second information indicating a second spatial area of a frame included in at least one second encoded video stream of the plurality of encoded video streams, and
wherein said first information and said second information indicate a corresponding spatial area on a frame.
